(19) United States
(12) Patent Application Publication
(10) Pub. No.: US 2024/0153035 A1
(43) Pub. Date: May 9, 2024

(54) METHOD AND APPARATUS WITH SUPER RESOLUTION

(71) Applicant: SAMSUNG ELECTRONICS CO., LTD., Suwon-si (KR)

(72) Inventors: Younghyun JO, Suwon-si (KR); Sehwan KI, Suwon-si (KR); Eunhee KANG, Suwon-si (KR); Hyong Euk LEE, Suwon-si (KR)

(73) Assignee: SAMSUNG ELECTRONICS CO., LTD., Suwon-si (KR)

(21) Appl. No.: 18/330,654

(22) Filed: Jun. 7, 2023

(30) Foreign Application Priority Data
Nov. 9, 2022 (KR) 10-2022-0148369
Dec. 23, 2022 (KR) 10-2022-0183315

(51) Int. Cl. G06T 3/40

(52) U.S. Cl. CPC G06T 3/4076; G06T 3/4046

(57) ABSTRACT

A processor-implemented method includes generating an adjusted reference patch by adjusting a position of a reference patch in a reference image based on a pixel value of a ground truth (GT) patch of a GT image and a pixel value of the reference patch, wherein the GT patch corresponds to a specific region of an input image; generating a super-resolution (SR) image of the input image using a SR model provided an input that is based on the generated adjusted reference patch; and training the SR model based on the SR image and the GT image.

### CROSS-REFERENCE TO RELATED APPLICATIONS

This application claims the benefit under 35 USC §119(a) of Korean Patent Application No. 10-2022-0148369 filed on Nov. 9, 2022, and Korean Patent Application No. 10-2022-0183315 filed on Dec. 23, 2022, in the Korean Intellectual Property Office, the entire disclosures of which are incorporated herein by reference for all purposes.

### BACKGROUND

### 1. Field

The following description relates to a method and apparatus with super-resolution (SR).

### 2. Description of Related Art

Super-resolution (SR) refers to a technique in computer vision that generates a high-quality output image from a low-resolution input image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method may include generating an adjusted reference patch by adjusting a position of a reference patch in a reference image based on a pixel value of a ground truth (GT) patch of a GT image and a pixel value of the reference patch, wherein the GT patch corresponds to a specific region of an input image; generating a super-resolution (SR) image of the input image using a SR model provided an input that is based on the generated adjusted reference patch; and training the SR model based on the SR image and the GT image.

The method may further include obtaining the reference patch corresponding to the specific region of the input image based on features extracted from the input image and features extracted from the reference image, wherein the specific region of the input image comprises a partial region in the input image with a preset number of first pixels, the reference patch comprises a partial region in the reference image with second pixels corresponding to the first pixels in the specific region of the input image, and the GT patch comprises a partial region in the GT image with third pixels corresponding to the first pixels in the specific region of the input image.

The obtaining of the reference patch may include performing the extraction of the features from the input image by extracting a non-flat region from the input image; and performing the obtaining of the reference patch corresponding to the specific region of the input image that belongs to the non-flat region of the input image, based on the features extracted from the input image and the features extracted from the reference image.

The adjusting of the position of the reference patch may include adjusting the position of the reference patch such that a search space determined based on the reference patch comprises search pixels having an intuited, by the SR model, small difference from pixel values of the third pixels in the GT patch.

The search space may include a region of a preset size in the reference image determined based on the position of the reference patch in the reference image.

The adjusting of the position of the reference patch may include standardizing a pixel value of the GT patch and a pixel value of the reference patch; and adjusting the position of the reference patch in the reference image based on a result of a comparison between the standardized pixel value of the GT patch and the standardized pixel value of the reference patch.

The standardizing may include standardizing pixel values of the third pixels in the GT patch based on a mean and a standard deviation of the pixel values of the GT patch; and standardizing pixel values of the second pixels in the reference patch based on a mean and a standard deviation of the pixel values of the reference patch.

The training of the SR model may include training the SR model based on a loss that is based on a difference between the SR image and the GT image.

The reference image may include a plurality of reference images captured with different resolutions.

In one or more general aspects, a processor-implemented method may include generating an adjusted reference patch by adjusting a position of a reference patch in a reference image based on a pixel value of a specific region of an input image and a pixel value of the reference patch; and generating an SR image of the input image using a super-resolution (SR) model provided an input that is based on the generated adjusted reference patch with the adjusted position.

The method may further include obtaining the reference patch corresponding to the specific region of the input image based on features extracted from the input image and features extracted from the reference image, wherein the specific region of the input image comprises a partial region of the input image with a preset number of first pixels, and the reference patch comprises a partial region in the reference image with second pixels corresponding to the first pixels in the specific region of the input image.

The adjusting of the position of the reference patch may include adjusting the position of the reference patch such that a search space determined based on the reference patch comprises search pixels having an intuited, by the SR model, small difference from pixel values of the specific region of the input image.

The search space may include a region of a preset size in the reference image determined based on the position of the reference patch in the reference image.

The adjusting of the position of the reference patch may include standardizing a pixel value of the specific region of the input image and a pixel value of the reference patch; and adjusting the position of the reference patch in the reference image based on a result of a comparison between the standardized pixel value of the specific region of the input image and the standardized pixel value of the reference patch.

The standardizing may include standardizing pixel values of the specific region of the input image based on a mean and a standard deviation of the pixel values of the specific region of the input image; and standardizing pixel values of pixels comprised in the reference patch based on a mean and a standard deviation of the pixel values of the second pixels in the reference patch.

In another general aspect, a processor-implemented super-resolution (SR) method may include generating an SR image of an input image output from a neural network-based SR model based on a reference patch in a reference image, wherein the SR model is a neural network having been trained to output a training SR image of training data using the training data and a training reference patch in a training reference image extracted based on a pixel value of a specific region of the training data.

The method may further include performing the training of the neural network, including based on features extracted from the training data and features extracted from the training reference image by an in-training SR model, obtaining the training reference patch corresponding to the specific region of the training data in the reference image; generating an adjusted reference patch by adjusting a position of the training reference patch in the training reference image based on a pixel value of a ground truth (GT) patch of a GT image and a pixel value of the training reference patch, the GT patch corresponding to the specific region of the training data; obtaining a training SR image of the training data output from the in-training SR model based on the generated adjusted reference patch with the adjusted position; and generating the SR model by training the in-training SR model based on the training SR image and the GT image.

A non-transitory computer-readable storage medium storing instructions that, when executed by a processor, may configure the processor to perform the method described above.

In another general aspect, an electronic device may include a processor configured to execute instructions; and a memory storing the instructions, which when executed by the processor configure the processor to: based on features extracted from an input image and features extracted from a reference image, obtain a reference patch corresponding to a specific region of the input image in the reference image; adjust a position of the reference patch in the reference image based on a pixel value of the specific region of the input image and a pixel value of the reference patch; and generate a super-resolution (SR) image of the input image based on an adjusted reference patch with an adjusted position.

In another general aspect, an electronic device may include a processor configured to execute instructions; and a memory storing the instructions, which when executed by the processor configure the processor to: generate a reference patch corresponding to a specific region of an input image in a reference image using a super-resolution (SR) model provided an input that is based on features extracted from the input image and features extracted from the reference image provided an input that is; and generate an SR image of the input image output from the SR model based on the reference patch, wherein the SR model comprises a neural network having inference implementation characteristics representing that the neural network has been trained to output a training SR image of training data from the training data and a training reference patch of a training reference image extracted based on a pixel value of a specific region of the training data.

Other features and aspects will be apparent from the following detailed description, the drawings, and the claims.

### BRIEF DESCRIPTION OF THE DRAWINGS

FIG. 1 illustrates an example method of training a super-resolution (SR) machine learning model according to one or more embodiments.

FIG. 2 illustrates an example position value of a reference patch corresponding to a pixel of an input image according to one or more embodiments.

FIG. 3 illustrates an example ground truth (GT) patch corresponding to a pixel of an input image according to one or more embodiments.

FIG. 4 illustrates an example of standardizing a pixel value and adjusting a position of a reference patch in a reference image according to one or more embodiments.

FIG. 5 illustrates an example method of training an SR model according to one or more embodiments.

FIG. 6 illustrates an example method of training an SR model in which feature matching and local matching are performed in parallel according to one or more embodiments.

FIG. 7 illustrates an example SR method according to one or more embodiments.

FIG. 8 illustrates an example inference method of an SR model according to one or more example embodiments.

FIG. 9 illustrates an example inference method of an SR model according to one or more example embodiments.

FIG. 10 illustrates an example apparatus according to one or more example embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C’, and the like are intended to have disjunctive meanings, and these phrases “at least one of A, B, and C”, “at least one of A, B, or C’, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

A deep learning-based single-image super-resolution (SISR) model at an early stage may have a performance that surpasses that of a typical SR model in terms of peak signal-to-noise ratio (PSNR), with the introduction of a new network architecture. After SISR, there have been attempts to solve various SR issues using deep learning. For example, there has been research on various SR techniques including, for example, perceptual SR that seeks perceptual quality instead of PSNR and blind SR that considers an unknown downsampling kernel. In addition, reference-based super-resolution (RefSR) is rapidly arising to overcome the limitations of SISR. RefSR aims to recover high-resolution images by utilizing an external reference image to generate rich textures.

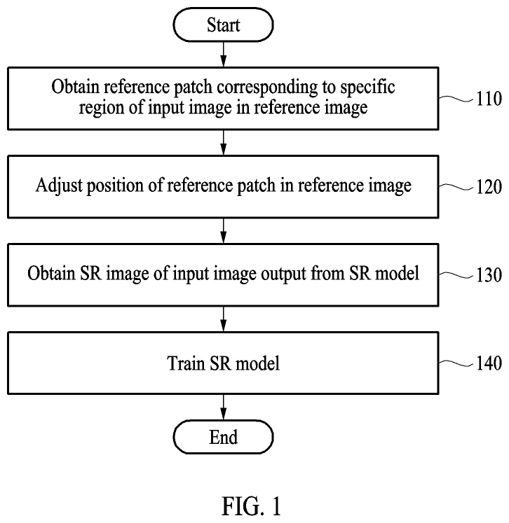

FIG. 1 illustrates an example method of training a super-resolution (SR) machine learning model according to one or more embodiments. Hereinafter, for convenience of explanation, examples will be described with respect to neural network(s) (NN) or various combinations of the same, but examples are not limited to the same as other machine leaning models or various combinations of the same are also available.

Referring to FIG. 1, an example method of training a SR machine learning model may include operations 110 through 130 performed by respective NN portions (respective NNs and/or NN portions making up the SR model) of the in-training SR model. In addition, operation 140 may utilize such NN portions when training the in-training SR model, e.g., through gradient backpropagation. However, examples are not limited to these operations, and any additional suitable operation(s) may be applied to the SR training described herein. The example method may start with operation 110, in which a reference patch of a reference image corresponding to a specific region of an input image is obtained based on features extracted from the input image and features extracted from the reference image by the SR model. In operation 120, a position of the reference patch in the reference image is adjusted based on a pixel value of a ground truth (GT) patch of a GT image and a pixel value of the reference patch. The GT patch may correspond to the specific region of the input image. In operation 130, the SR model generates an SR image of the input image based on the reference patch with the adjusted position. In operation 140, the SR model is trained based on the generated SR image and the GT image. Each of the operations 110 through 140 will be described in greater detail below.

In an example, the SR model may include a NN feature extractor configured to perform image feature extraction. The feature extraction may include a visual geometry group (VGG) network, as a non-limiting example. Hereinafter, features extracted from the VGG network will be referred to as VGG features. The reference patch corresponding to the specific region of the input image may be obtained through matching of VGG features of the input image and VGG features of the reference image.

In an example, the input image may be a low-resolution image compared to the reference image. The reference image may include a plurality of images captured with different resolutions. These captured images may be used to obtain an SR image corresponding to one input image. Moreover, the plurality of images in the reference image may be captured by multiple cameras of an example portable electronic device such as a smartphone or the like.

In an example, the specific region of the input image may be a partial region of the input image, and include a preset number of pixels (first pixels). In one example, the specific region of the input image may be a rectangular region that may have a size of n×m(n representing the number of horizontal pixels and m representing the number of vertical pixels in the input image). In this example, the specific region of the input image may include one pixel of the input image.

In an example, the reference patch may be a partial region in the reference image and include a preset number of pixels (second pixels) including reference pixel. A size of the reference patch may be the same as or different from a size of the specific region of the input image. In one example, the reference patch may be a rectangular region that may have a size of p×q (p representing the number of horizontal pixels and q representing the number of vertical pixels in the reference image). The rectangular reference patch (p×q) of the reference image may correspond to the rectangular specific region (n×m) of the input image.

In one example, each reference patch may be specified by a position in the reference image. Based on the specified position, pixels included in each reference patch may change. Different reference patches may have different specified positions in the reference image. A specified position of a reference patch may include at least one pixel included in the reference patch. For example, when a reference patch is a rectangular region including p×q pixels of the reference image, the reference patch may be specified as a position of a pixel located at a top leftmost end among pixels included in the rectangular reference patch (p×q).

Operation 110 may include obtaining a position value of the reference patch in the reference image corresponding to a specific pixel (or a first pixel) of the input image. An obtained position value of the reference patch may represent a reference pixel of the reference patch corresponding to a specific pixel of a specific region of the input image. In one example, when the size of the specific region of the input image is n×m, the specific region of the input image based on the specific pixel may be a rectangular region of the size of n×m in which the specific pixel is located at a top leftmost end of the rectangular region (n×m). On the other hand, the reference pixel of the reference patch may be a pixel located at the top leftmost end of the reference patch. When the preset size of the reference patch is p×q, the reference patch may be a rectangular region (p×q) in which the reference pixel is a first pixel located at the top leftmost end of the rectangular region (p×q).

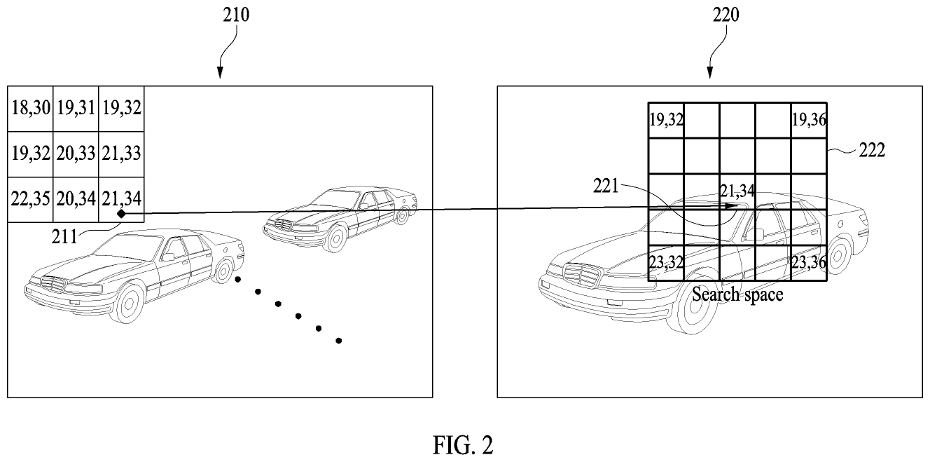

In one example, referring to FIG. 2, there are example rectangles in an input image 210 that may correspond to respective pixels of the input image 210. There are also example rectangles in a reference image 220 that may correspond to respective pixels of the reference image 220. Values indicated in each rectangle in the input image 210 may correspond to row and column values of a position of a corresponding reference pixel of a reference patch of the reference image 220.

FIG. 2 illustrates five example reference pixels in the reference patch of the reference image 220. Reference numeral 221 represents a pixel (21,34) located in a 21st row and a 34th column of the reference image 220. Other four pixels are pixel (19, 32) located in a 19st row and a 32th column, pixel (19, 36) located in a 19st row and a 36th column, pixel (23, 32) located in a 23st row and a 32th column, and pixel (23, 36) located in a 23st row and a 36th column of the reference image 220.

. The reference patch of the reference image 220 corresponds to a specific region of the input image 210. In one example, when the size of the specific region of the input image 210 is 1×1, the specific region of the input image 210 that is based on the specific pixel may be a region having only the specific pixel. In another example, when the size of the specific region of the input image 210 is 2×2, the specific region of the input image 210 that is based on the specific pixel located in a first row and a first column may be a region including 4 pixels, which are the specific pixel located in the first row and the first column and other three pixels, which are a pixel located in the first row and a second column, a pixel located in a second row and the first column, and a pixel located in the second row and the second column.

In one example, a reference pixel 221 of a reference patch may be a pixel (21, 34) located in a 21st row and a 34th column of the reference image 220, and correspond to a pixel 211 located in a third row and a third column of the input image 210. In this example, when the size of the reference patch is 2×2, the reference patch may be a region of the size of 2×2 including the reference pixel 221 located in the 21st row and the 34th column. Also, the reference pixel 221 may be located at a top leftmost end of the region (2×2), which may include the reference pixel 221 located in the 21st row and the 34th column, a pixel located in the 21st row and a 35th column, a pixel located in a 22nd row and the 34th column, and a pixel located in the 22nd row and the 35th column. In another example, the reference pixel 221 may be located at a suitable position other than the top leftmost end of the region (2×2).

Referring back to FIG. 1, the SR model may include a NN portion configured to perform operation 120 of adjusting the position of the reference patch of the reference image based on a pixel value of a ground truth (GT) patch of a GT image and a pixel value of the reference patch of the reference image. The GT patch of the GT image may correspond to the specific region of the input image.

In an example, the GT patch may be a partial region in the GT image and include pixels (third pixels) in the GT image corresponding to pixels included in the specific region of the input image. The GT image may be a high-resolution version of the input image. In one example, the GT image may include an image obtained with a higher resolution than the input image by capturing an image of the same object in the same composition as the input image. In another example, the GT image may include an image converted to have a high resolution by implementing an SR algorithm (e.g., bicubic interpolation) to the input image.

The GT patch may be a region corresponding to the specific region of the input image in an SR image of the input image. In one example, when the GT image is an image obtained by upscaling the input image by a magnification of 2, the GT patch in the GT image, which corresponds to a pixel region located in an xth row and a yth column of the input image, may be a region including a pixel located in a (x×2−1) row and a (y×2−1) column, a pixel located in the (x×2−1) row and a (y×2) column, a pixel located in a (x×2) row and the (y×2−) column, and a pixel located in the (x×2) row and the (y×2) column.

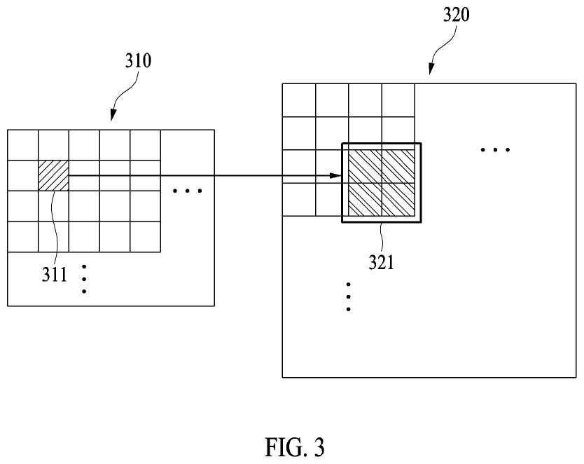

In one example, referring to FIG. 3, when one rectangle indicates one pixel, a GT patch 321 in a GT image 320 may correspond to a pixel region 311 located in a second row and a second column of the input image 310. In this example, the GT patch 321 may include four pixels—a pixel located in a third row and a third column, a pixel located in the third row and a fourth column, a pixel located in a fourth row and the third column, and a pixel located in the fourth row and the fourth column in the GT image 320.

Referring back to FIG. 1, in operation 120, the position of the reference patch may be adjusted such that a search space may be determined based on the reference patch and include pixels (search pixels) having a determined or intuited, by the SR model, small difference from pixel values of pixels included in the GT patch. In one example, the search space may include a region of a preset size in the reference image that is determined based on the position of the reference patch in the reference image. For example, the search space may include the reference patch and a region around the reference patch. The region may include pixels located within a preset range. For example, referring to FIG. 2, a search space 222 may be determined as a region of the size of 5×5 including pixels (19, 32), (19, 36), (23, 32) and (23, 36) that are located within a preset range around a reference pixel 221 in a reference patch.

In an example, one or more candidate reference patches corresponding to the specific region of an input image may be extracted from the search space of a reference image. Based on a result of comparing pixel values of pixels included in the candidate reference patches and a pixel value of a pixel included in the specific region, the reference patch may be changed to one of the candidate reference patches that has a most similar pixel value to the pixel value of the specific region among the candidate reference patches.

In an example, operation 120 of adjusting the position of the reference patch may include standardizing a pixel value of the GT patch and a pixel value of the reference patch, and adjusting the position of the reference patch in the reference image based on a result of a comparison between the standardized pixel value of the GT patch and the standardized pixel value of the reference patch.

In an example, the standardizing may include standardizing pixel values of pixels included in the GT patch based on a mean and a standard deviation of the pixel values of the pixels included in the GT patch. The standardizing may include standardizing pixel values of pixels included in the reference patch based on a mean and a standard deviation of the pixel values of the pixels included in the reference patch.

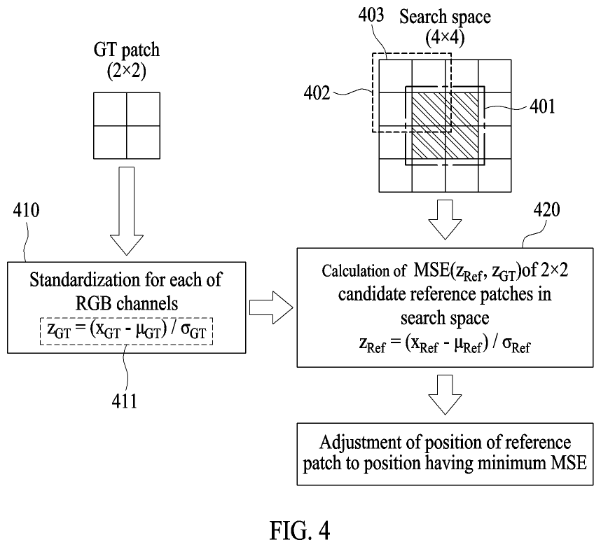

For example, referring to FIG. 4, red, green, blue (RGB) channel-based standardization 410 may be performed to standardize a pixel value of a GT patch corresponding to a specific region of an input image. The pixel value may include an R value, a G value, and a B value, and the RGB channel-based standardization 410 may be performed to standardize each of the R value, the G value, and the B value. In a standardization equation 411, XGT denotes a pixel value of a pixel included in the GT patch, p GT denotes a mean of pixel values of pixels included in the GT patch, and G GT denotes a standard deviation of the pixel values of the pixels included in the GT patch.

One or more candidate reference patches corresponding to the specific region of the input image may be extracted from a search space determined as a partial region of the reference image. The search space may be determined based on the reference patch obtained in operation 110 described above with refence to FIG. 1. In one example, the search space may be determined as a region of the size of 4×4 including pixels located within a preset range including a region 401 corresponding to the reference patch in the reference image. The RGB channel-based standardization 410 may be performed on each of the candidate reference patches extracted from the search space, and calculation 420 may be performed to calculate a difference in pixel values between a standardized candidate reference patch z_{Ref} and a standardized GT patch z_{GT}. For example, the difference in pixel values between the standardized candidate reference patch z_{Ref} and the standardized GT patch z_{GT} may be calculated as a mean square error (MSE). The position of the reference patch may be adjusted to a position of a candidate reference patch having a minimum MSE value among the candidate reference patches extracted from the search space. For example, when a candidate reference patch corresponding to a region 402 has the minimum MSE value, the position of the reference patch may be changed from the region 401 to the region 402. A position of a pixel 403 may be stored as the position of the reference patch corresponding to the specific region of the input image.

Referring back to FIG. 1, the method of training the SR model may include a NN portion configured to perform operation 130 of obtaining an SR image of the input image. The SR image may be output from the SR model based on a reference patch with the adjusted position. The SR model may include a NN portion configured to convert the specific region of the input image to a high-resolution image based on the reference patch. For example, the SR model may utilize a neural network to perform SR on the input image through a texture transfer of the reference patch.

The method of training an SR model may include operation 140, in which the SR model is trained based on the SR image and the GT image. For example, the training in operation 140 may include training the SR model based on a loss function that is based on a difference between the SR image and the GT image. Based on the loss function, weights of each layer of the neural network included in the SR model may be adjusted, e.g., until the SR model reaches a threshold accuracy. Operation 140 may include performing loss backpropagation, e.g., back through the NN portions utilized for operations 110-130, for example. In an example, the in-training SR model may include a loss generation NN portion, which can be removed from the finally trained SR model. In an example, the NN portions of the SR model may each represent one or more neural network layers of a neural network making up the SR model, and/or a combination of respective neural networks, each of one or more hidden layers, making up the SR model.

In an example, operation 110 of obtaining the reference patch may include extracting a non-flat region from the input image, and obtaining the reference patch corresponding to the specific region belonging to the non-flat region of the input image based on the features extracted from the input image and the features extracted from the reference image. The non-flat region may include an edge in the image or a region in which there is a change in texture. For example, to extract the non-flat region, edge detection may be performed on the input image. The non-flat region may also be a region with high frequency information compared to flat region that may include primarily low frequency information.

In one example method of training the SR model, operation 120 of adjusting the position of the reference patch may be only performed on the non-flat region, and not on a flat region, thereby reduce the amount of computation and time to be used for the method of training the SR model.

In an example, the SR model trained by the above-described method including operations 110 through 140 may generate the SR image of the input image. The generated SR image is a high-resolution version of the input image from a combination of the input image and the reference image. A method of performing image SR based on such a trained SR model will be described in detail below.

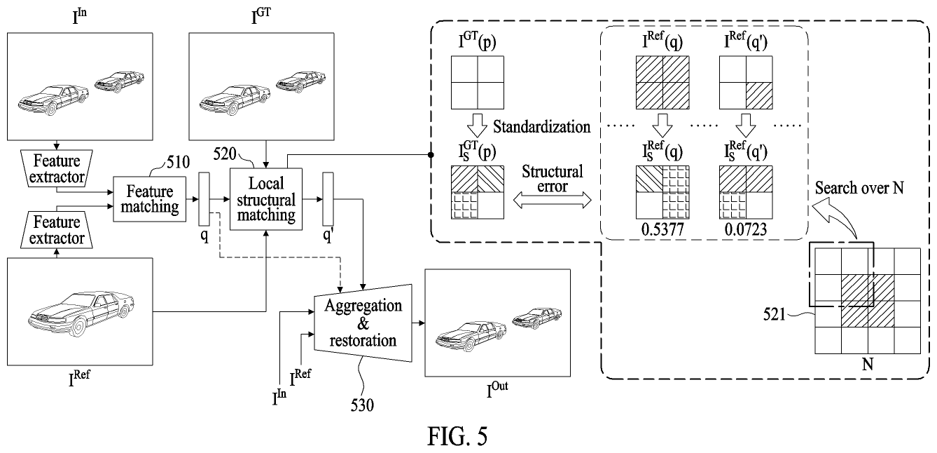

FIG. 5 illustrates an example method of training an SR model according to one or more embodiments.

Reference-based super-resolution (RefSR) may refer to a technique of performing SR on a given low-resolution input image by using high-quality texture information of a reference image. RefSR aims to enhance detailed high-frequency information of an output image by borrowing a rich texture from the reference image (Ref). The reference image may be used to generate a realistic texture.

Referring to FIG. 5, RefSR may be divided into two parts: a correspondence matching process and an aggregation and restoration process. The correspondence matching process may include performing feature matching 510 to find a corresponding position of a reference image I^{Ref} for each region of an input image I^{In}. In one example, to find the corresponding position between the input image In and the reference image I^{Ref}, a method of comparing VGG features of the input image In and the reference image I^{Ref} may be used. In one example, the feature matching 510 for finding the corresponding position of the reference image I^{Ref} for each region of the input image I^{In} may correspond to operation 110 of obtaining a reference patch of a reference image corresponding to a specific region of an input image (e.g., the input image I^{In}), which is described above with reference to FIG. 1.

A VGG feature may include high-level semantic information, which may not be effective for finding a low-level texture. For example, a reference patch extracted with the highest VGG feature correlation may be different from GT data or a texture of a GT patch of a GT image. The correspondence matching process may include performing pixel-level local structural matching 520 to use a reference patch that is highly correlated with a pixel of the input image for image restoration (or SR) after the feature matching 510. To find the reference patch similar to the texture of the GT data in the reference image I^{Ref}, the local structural matching 520 in a pixel space may be performed after the feature matching 510 in a feature space. In an example method of training the SR model, providing the model with the reference patch having a texture that is close to the GT data in relation to the input image may improve the performance of an aggregation and restoration (AR) 530 portion of the SR model. For example, the AR 530 may be a NN portion of the SR model. To measure an image structural difference between the GT patch and the reference patch, a degree of structural correspondence in an RGB domain may be calculated. Through the local structural matching 520, the reference patch having a similar texture to that of the GT patch in the pixel space may be determined.

Subsequently, the extracted texture information of the reference image I^{Ref} may be transferred and aligned with respect to the input image I^{In}. Then, the aggregation and restoration process may be performed to fuse the texture of the input image with the transferred reference texture to generate a texture-enhanced output image. The AR 530 may refer to the reference patch that has a high correlation with the input image in the training of the SR model.

The local structural matching 520 may be performed within a small neighboring region around an initial corresponding position q in the reference image obtained by the feature matching 510. As a result of performing the local structural matching 520, an adjusted (or refined) corresponding position q′ may be obtained. A search space N 521 in the reference image for the local structural matching 520 may be determined by the feature matching 510. In one example, the local structural matching 520 for obtaining the adjusted corresponding position q′ may correspond to operation 120 of adjusting the position of the reference patch in the reference image, which is described above with reference to FIG. 1.

In an example, the reference patch semantically and structurally similar to the GT patch may be obtained through the local structural matching 520. The local structural matching 520 may be expressed by Equation 1.

$${q}^{′} = {argmin}_{j ; j ∈ N} M S E ( {I}_{S}^{GT} ( p ) , {I}_{S}^{Ref} ( j ) ) \qquad Equation 1$$

In Equation 1, I(x) denotes a pixel value of a pixel at a position x of an image I, MSE denotes a mean square error, and S denotes a standardization operator.

As described above, in the example training method, I^{GT} may be used, instead of I^{In}, to match I^{Ref}. The more similar the texture of the reference patch is to the texture of the GT patch, the more the AR 530 may actively transfer and utilize the reference texture. By the example training method, a reference patch including a color and structure less correlated with the input image may not be used to train the AR 530.

The standardization may refer to a normalization process using a mean p and a standard deviation σ. A standardized image patch Iₛ(i) corresponding to a region i may be calculated as expressed by Equation 2.

$${I}_{S} ( i ) = \frac{I ( i ) - μ ( I ( i ) )}{σ ( I ( i ) )} \qquad Equation 2$$

The GT patch and the reference patch may be standardized such that each patch is robust against a color difference and an image structural difference when calculating a structural error.

A reference patch I^{Ref}(q′) with the position adjusted by the local structural matching 520 may have a color, an image structure, and a texture that are determined highly similar to those of the corresponding GT patch, when compared to I^{Ref}(q). In addition, by comparing a semantic feature correlation value of each reference patch with the corresponding GT patch and a score based on a local structural matching error value, I_{Ref}(q′) may have 0.5377, which is higher than I^{Ref}(q) having 0.0723.

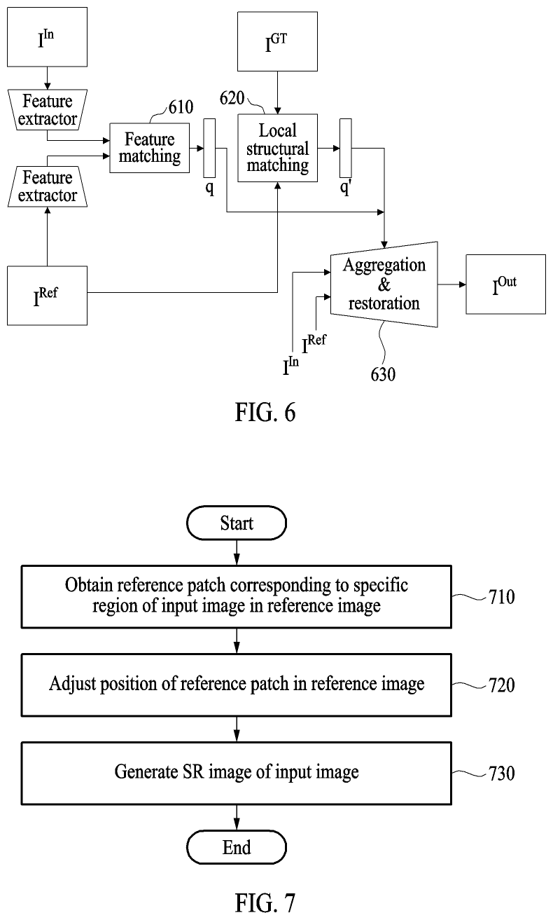

FIG. 6 illustrates an example method of training an SR model in which feature matching and local matching are performed in parallel according to one or more embodiments.

Referring to FIG. 6, feature matching 610 and local matching 620 may be performed in parallel, e.g., respective corresponding NN portions of the SR model may be implemented in parallel. In one example, the local matching 620 may extract a reference patch similar to a corresponding GT patch from a reference image without receiving a corresponding position q of the reference patch obtained as a result of the feature matching 610. The local matching 620 may extract a reference patch having a pixel value determined highly similar to the corresponding GT patch using an entire reference image as a search space, without limiting the search space to a partial region in the reference image that is determined based on the reference patch obtained by the feature matching 610.

In an example, an aggregation and restoration (AR) 630 portion of the SR model, e.g., an AR NN portion of the SR model, may be configured to perform an aggregation and restoration process based on a corresponding position q of the reference patch obtained as a result of the feature matching 610 and a corresponding position q′ of the reference patch obtained as a result of the local matching 620.

FIG. 7 illustrates an example SR method according to one or more embodiments.

Referring to FIG. 7, a method of performing SR (also simply referred to herein as an SR method) may include operation 710 of obtaining a reference patch corresponding to a specific region of an input image in a reference image based on features extracted from the input image and features extracted from the reference image, operation 720 of adjusting a position of the reference patch in the reference image based on a pixel value of the specific region of the input image and a pixel value of the reference patch, and operation 730 of generating an SR image of the input image based on a reference patch with the adjusted position.

In an example, the SR method may correspond to a method of operating an apparatus implementing an SR model that is trained by the training method described above with reference to FIG. 1 as a non-limiting example. In one example, the SR method may be performed by a processor of the apparatus in which the SR model is implemented. An example configuration of the apparatus will be described in detail below.

Operation 710 may correspond to operation 110 described above with reference to FIG. 1.

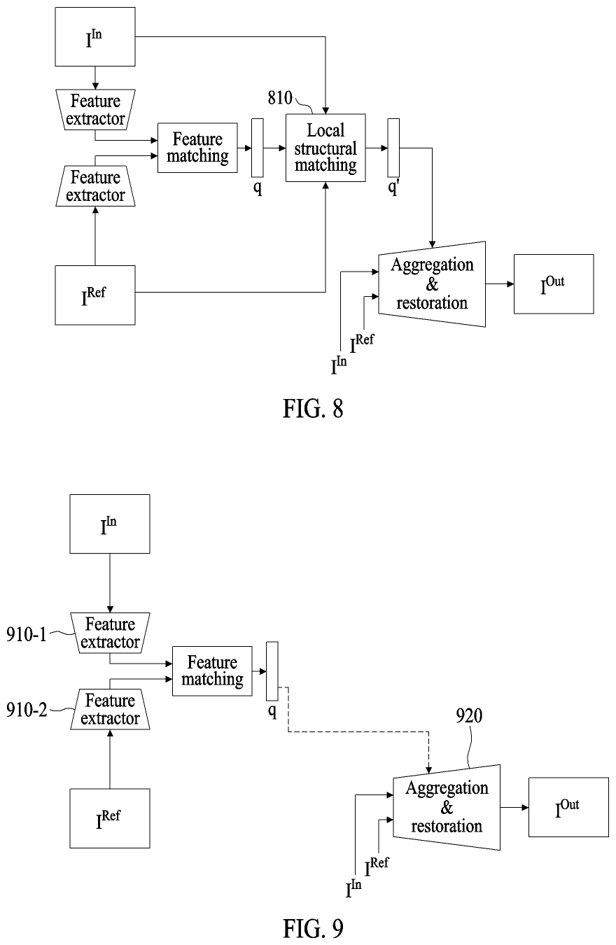

Operation 720 may be different from operation 120, which uses a pixel value of a GT patch and a pixel value of the specific region of the input image with reference to FIG. 1. Operation 720 uses an inference step of the SR model, in which the GT image of the input image may not be input to the model, and thus the pixel value of the specific region of the input image may be used, instead of the GT patch of the GT image, to adjust the position of the reference patch. As an example, FIG. 8 illustrates an example inference method of an SR model, the input image may be used for local structural matching 810, instead of the GT patch.

Operation 720 of adjusting the position of the reference patch may include adjusting the position of the reference patch such that a search space determined based on the reference patch includes pixels having a determined or intuited, by the SR model, small difference from pixel values of pixels in the specific region of the input image. A difference between a pixel value of the reference patch and a pixel value of the specific region of the input image may be calculated to be a MSE, for example.

Operation 720 of adjusting the position of the reference patch may include standardizing the pixel value of the specific region and the pixel value of the reference patch, and adjusting the position of the reference patch in the reference image based on a result of a comparison between the standardized pixel values of the specific region and the reference patch. That is, the position of the reference patch may be adjusted based on the difference in the standardized pixel values.

In an example, the SR model may include an aggregation and restoration (AR) portion having a texture transfer capability that is improved by the training method described above with reference to FIG. 1, and may thus generate an SR image of an input image having an improved quality, even though a reference patch is obtained using a specific region of the input image.

FIG. 9 illustrates an example inference method of an SR model according to one or more embodiments.

In an example, an SR method may include obtaining a reference patch of a reference image corresponding to a specific region of an input image based on features extracted from the input image and features extracted from the reference image by an SR model, and obtaining an SR image of the input image output from the SR model based on the reference patch.

The SR model may be a trained neural network, e.g., trained to output an SR image of training data from the training data and a reference patch of a reference image extracted based on a pixel value of a specific region of the training data.

The SR model may be a neural network, having various combinations of neural network portions (i.e., respective neural network portions or layer(s), or respective neural networks that may also be respectively trained), which is trained by a training method that is described above with reference to FIG. 1, as a non-limiting example. For example, the SR model may include feature extractors 910-1 and 910-2 for feature extraction and an aggregation and restoration (AR) 920 portion of the SR model for SR image generation, as respective neural network portions of the SR model.

Referring to FIG. 9, local structural matching may not be performed in the inference method of the SR model. Rather, AR 920 may generate an SR image corresponding to an input image from a corresponding position q in a reference image that is obtained by feature matching. For example, the SR model that is implemented for inference operations may not include neural network portion(s) corresponding to the local structural matching that may be included in the in-training SR model. Likewise, a loss layer that may be included in the in-training SR model may also not be included in the SR model implemented for inference operations.

In an example, the SR model may include another restoration neural network portion (or the AR 920 may perform the same), having a texture transfer capability that is improved by the training method described above with reference to FIG. 1 as a non-limiting example, and may thus generate an SR image of the input image having an improved quality even when using a reference patch obtained by the feature matching without position adjustment. Herein, while various portions of the SR are described as machine learning portions of the machine learning SR model, some portions of the SR model may include non-machine learning portions, e.g., algorithms, to perform less than all operations described herein with respect to the SR models.

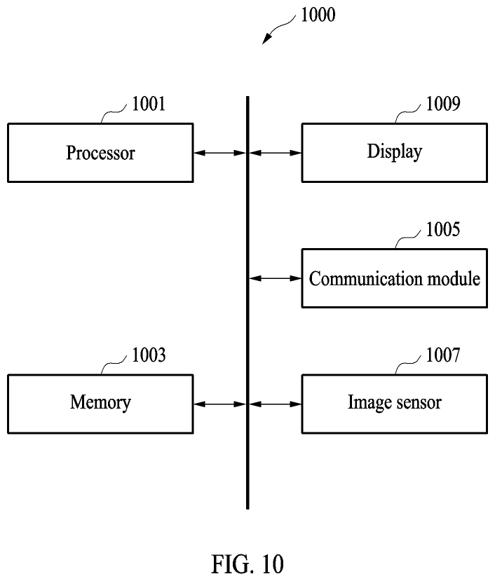

FIG. 10 illustrates an example electronic device with SR according to one or more embodiments.

Referring to FIG. 10, the electronic device 1000 may include a processor 1001, a memory 1003, a communication system 1005, an image sensor 1007, and a display 1009. The electronic device 1000 may be an apparatus that implements the SR model described above with reference to FIGS. 1 through 9, e.g., SR model training and/or inference implementation of a trained SR model, along with additional operations and functions of the electronic device 1000, such as typical smartphone operations and functions, which may further be configured to utilize the SR model in various operations and functions of the smartphone. In addition to a smartphone, the electronic device 1000 may be an alternative smart device, a personal computer (PC), a tablet PC, and the like, as non-limiting examples.

As a non-limiting example, image sensor 1007 may be configured to capture the input images, and the display 1009 may be configured to display the generated output super resolution result images.

The processor 1001 may be configured to perform one or more or all operations described above with reference to FIGS. 1 through 6 and/or 7 through 9.

In an example, the operations of training the SR model described above with reference to FIG. 1 may be performed in the electronic device 1000 or a server. When the electronic device is a server or server system, the SR model trained in the server may be communicated to, and stored in, the electronic device 1000, and the operations of the SR method may be performed by the processor 1001 of the electronic device 1000.

The memory 1003 may be a volatile or non-volatile memory, and may store data relating to the SR method described above with reference to FIGS. 1 through 9. For example, the memory 1003 may store data generated during the SR method or data required for performing the SR method. The memory 1003 may store the SR model and/or the various instructions of the in-training SR model, as well as other programs.

The communication system 1005, e.g., though a wired, wireless, or other communication interface hardware, may provide a function for the apparatus 1000 to communicate with other electronic devices or other servers through a network. For example, the electronic device 1000 may be connected to an external device (e.g., a user terminal, a server, or a network) through the communication system 1005 to exchange data therewith.

In an example, the memory 1003 may store computer readable instructions to configure the processor 1001 to perform in which the SR operations and/or methods described above with reference to FIGS. 1 through 6 and/or 7 through 9. The processor 1001 may be configured to execute the various instructions, e.g., stored in the memory 1003, and as a result configure the processor 1001 to control the electronic device 1000 to perform the various operation and functions of the electronic device 1000, as well as instructions that the execution of the same configure the processor 1001 to perform one or more or all operations and/or methods described herein.

The electronic device 1000 may further include other components not shown in the accompanying drawings. For example, the apparatus 1000 may further include an input/output interface including an input device and an output device as a means for interfacing with the communication system 1005. For another example, the electronic device 1000 may further include other components such as a transceiver, various sensors, and a database (DB)

The processors, memories, electronic devices, apparatuses, processor 1001, memory 1003, communication system 1005, image sensor 1007, and display 1009, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, comprising:
generating an adjusted reference patch by adjusting a position of a reference patch in a reference image based on a pixel value of a ground truth (GT) patch of a GT image and a pixel value of the reference patch, wherein the GT patch corresponds to a specific region of an input image;
generating a super-resolution (SR) image of the input image using a SR model provided an input that is based on the generated adjusted reference patch; and
training the SR model based on the SR image and the GT image.

2. The method of claim 1, further comprising:
obtaining the reference patch corresponding to the specific region of the input image based on features extracted from the input image and features extracted from the reference image,
wherein the specific region of the input image comprises a partial region in the input image with a preset number of first pixels,
the reference patch comprises a partial region in the reference image with second pixels corresponding to the first pixels in the specific region of the input image, and
the GT patch comprises a partial region in the GT image with third pixels corresponding to the first pixels in the specific region of the input image.

3. The method of claim 2, wherein the obtaining of the reference patch comprises:
performing the extraction of the features from the input image by extracting a non-flat region from the input image; and
performing the obtaining of the reference patch corresponding to the specific region of the input image that belongs to the non-flat region of the input image, based on the features extracted from the input image and the features extracted from the reference image.

4. The method of claim 1, wherein the adjusting of the position of the reference patch comprises:
adjusting the position of the reference patch such that a search space determined based on the reference patch comprises search pixels having an intuited, by the SR model, small difference from pixel values of the third pixels in the GT patch.

5. The method of claim 4, wherein the search space comprises a region of a preset size in the reference image determined based on the position of the reference patch in the reference image.

6. The method of claim 1, wherein the adjusting of the position of the reference patch comprises:
standardizing a pixel value of the GT patch and a pixel value of the reference patch; and
adjusting the position of the reference patch in the reference image based on a result of a comparison between the standardized pixel value of the GT patch and the standardized pixel value of the reference patch.

7. The method of claim 6, wherein the standardizing comprises:
standardizing pixel values of the third pixels in the GT patch based on a mean and a standard deviation of the pixel values of the GT patch; and
standardizing pixel values of the second pixels in the reference patch based on a mean and a standard deviation of the pixel values of the reference patch.

8. The method of claim 1, wherein the training of the SR model comprises:
training the SR model based on a loss that is based on a difference between the SR image and the GT image.

9. The method of claim 1, wherein the reference image comprises a plurality of reference images captured with different resolutions.

10. A processor-implemented method, comprising:
generating an adjusted reference patch by adjusting a position of a reference patch in a reference image based on a pixel value of a specific region of an input image and a pixel value of the reference patch; and
generating an SR image of the input image using a super-resolution (SR) model provided an input that is based on the generated adjusted reference patch with the adjusted position.

11. The method of claim 10, further comprising:
obtaining the reference patch corresponding to the specific region of the input image based on features extracted from the input image and features extracted from the reference image,
wherein the specific region of the input image comprises a partial region of the input image with a preset number of first pixels, and
the reference patch comprises a partial region in the reference image with second pixels corresponding to the first pixels in the specific region of the input image.

12. The method of claim 10, wherein the adjusting of the position of the reference patch comprises:
adjusting the position of the reference patch such that a search space determined based on the reference patch comprises search pixels having an intuited, by the SR model, small difference from pixel values of the specific region of the input image.

13. The method of claim 12, wherein the search space comprises a region of a preset size in the reference image determined based on the position of the reference patch in the reference image.

14. The method of claim 10, wherein the adjusting of the position of the reference patch comprises:
standardizing a pixel value of the specific region of the input image and a pixel value of the reference patch; and
adjusting the position of the reference patch in the reference image based on a result of a comparison between the standardized pixel value of the specific region of the input image and the standardized pixel value of the reference patch.

15. The method of claim 14, wherein the standardizing comprises:
standardizing pixel values of the specific region of the input image based on a mean and a standard deviation of the pixel values of the specific region of the input image; and
standardizing pixel values of pixels comprised in the reference patch based on a mean and a standard deviation of the pixel values of the second pixels in the reference patch.

16. A processor-implemented super-resolution (SR) method, comprising:
generating an SR image of an input image output from a neural network-based SR model based on a reference patch in a reference image,
wherein the SR model is a neural network having been trained to output a training SR image of training data using the training data and a training reference patch in a training reference image extracted based on a pixel value of a specific region of the training data.

17. The method of claim 16, further comprising:
performing the training of the neural network, including:
based on features extracted from the training data and features extracted from the training reference image by an in-training SR model, obtaining the training reference patch corresponding to the specific region of the training data in the reference image;
generating an adjusted reference patch by adjusting a position of the training reference patch in the training reference image based on a pixel value of a ground truth (GT) patch of a GT image and a pixel value of the training reference patch, the GT patch corresponding to the specific region of the training data;
obtaining a training SR image of the training data output from the in-training SR model based on the generated adjusted reference patch with the adjusted position; and
generating the SR model by training the in-training SR model based on the training SR image and the GT image.

18. A non-transitory computer-readable storage medium storing instructions that, when executed by a processor, configure the processor to perform the method of claim 1.

19. An electronic device comprising:
a processor configured to execute instructions; and
a memory storing the instructions, which when executed by the processor configure the processor to:
based on features extracted from an input image and features extracted from a reference image, obtain a reference patch corresponding to a specific region of the input image in the reference image;
adjust a position of the reference patch in the reference image based on a pixel value of the specific region of the input image and a pixel value of the reference patch; and
generate a super-resolution (SR) image of the input image based on an adjusted reference patch with an adjusted position.

20. An electronic device comprising:
a processor configured to execute instructions; and
a memory storing the instructions, which when executed by the processor configure the processor to:
generate a reference patch corresponding to a specific region of an input image in a reference image using a super-resolution (SR) model provided an input that is based on features extracted from the input image and features extracted from the reference image provided an input that is; and
generate an SR image of the input image output from the SR model based on the reference patch,
wherein the SR model comprises a neural network having inference implementation characteristics representing that the neural network has been trained to output a training SR image of training data from the training data and a training reference patch of a training reference image extracted based on a pixel value of a specific region of the training data.
